(19) United States
(12) Patent Application Publication
(10) Pub. No.: US 2005/0238068 A1
(43) Pub. Date: Oct. 27, 2005

(54) Frequency tunable optical RF source

(76) Inventors: Suning Tang, Fremont, CA (US); Xiao Yi Wang, San Jose, CA (US)

Correspondence Address: CHARLES QIAN, 1018 CRANBERRY DR, CUPERTINO, CA, 95014, US

(21) Appl. No.: 10/832,560

(22) Filed: Apr. 27, 2004

(51) Int. Cl. H01S 3/10

(52) U.S. Cl. 372/20

(57) ABSTRACT

A method and apparatus for generating frequency tunable radio-frequency (RF) pulses utilizing a tunable cavity solid-state laser are disclosed. In one preferred embodiment, an optical RF source provides optical pulses with 1 to 200 GHz repetition rate. The disclosed optical RF source consists of a pump laser and mode matching optics, a pump beam coupler, a laser cavity end mirror, a laser gain medium, a Saturable Bragg Reflector, and a mechanism to change the effective optical length of the laser cavity. By adjusting the effective optical cavity length between the cavity end mirror that also serves as laser output coupler and Saturable Bragg Reflector that also serves as the other end mirror of the cavity, the repetition rate of the output optical pulses is changed. In another preferred embodiment, an optical RF source consists of a pump laser and mode matching optics, a Saturable Bragg Reflector that also serves as a pump coupler, a laser cavity end mirror that also serves as laser output coupler, a laser gain medium, and a mechanism to change the effective optical length of the laser cavity. By adjusting the effective optical cavity length between the cavity end mirror and Saturable Bragg Reflector, the repetition rate of the output optical pulses is changed. In yet another preferred embodiment, an optical RF source further includes an optical to electrical signal converter, and at least one of the following: a RF connector, a connecting waveguide, and a coaxial transmission cable with at least one terminating, impedance matching resistor. In an additional preferred embodiment, an optical RF source consists of a pump laser and mode matching optics, a Saturable Bragg Reflector that also serves as an output coupler and laser cavity end mirror, a second laser cavity end mirror also serving as pump coupler, a laser gain medium, and a mechanism to change the effective optical cavity length of the laser. By adjusting the effective optical cavity length between the cavity end mirrors, the repetition rate of the output optical pulses is changed.

### BACKGROUND OF THE INVENTION

1. Field of the Invention

The present invention relates generally to radio-frequency (RF) devices and more particularly to a method and apparatus for generating RF signals utilizing optical components.

2. Background Art

Frequency tunable, stable microwave and RF sources are critical to many civilian and military applications. Traditionally, such RF and microwave sources are electrical in nature and it is often costly to manufacture high frequency (>10 GHz) sources. Recently, due to the advances of optical science and technologies, light sources with ultra short pulse durations (pulse width of 10⁻¹⁵ to 10⁻¹⁰ sec) and high repetition rates (up to 200 GHz) became feasible. These optical sources, following optical to electrical conversions, may provide an alternative to conventional microwave and RF sources, with frequency of 1 GHz to 200 GHz. The present invention relates closely to conventional RF and laser technologies and in particular, to passively mode-locked solid-state lasers. There are several prior art passively mode-locked laser technologies and the most relevant patents to the present invention appear to be U.S. Pat. No. 6,625,192 to Arbel, et al., issued on Sep. 23, 2003, U.S. Pat. No. 5,305,336 to Adar et al, U.S. Pat. No. 6,570,892 to Hong Lin, issued on May 27, 2003; and a relevant article titled “Gigahertz-repetition-rate mode locked fiber laser for continuum generation,” appeared in Optics Letters, vol. 25, pp. 1418-1420, 2000. These patents and article are thereby included herein by ways of reference.

A typical prior art passively mode-locked laser is depicted in FIG. 1. The laser consists of a collimated pump source 110 with an optical pump beam 115, an output-deflecting pump coupler 120, a pump focusing lens 130, a cavity end mirror that also serves as laser output coupler 140, a laser gain medium 150, and a Saturable Bragg Reflector (SBR) 160. The pump source 110 typically is a semiconductor laser with an output wavelength centered about 808 nm. The output-deflecting pump coupler 120 transmits the pump beam at 808 nm while deflecting the laser output at 1064 nm. Normally, the surface of the output-deflecting pump coupler facing the pump source is coated with an anti-reflective coating whereas the surface facing the laser cavity is deposited with a dielectric coating which passes the pump beam at 808 nm while deflecting the laser output at 1064 nm. The function of the lens 130 is to focus the collimated pump beam on the laser gain medium 150 to stimulate laser operation. The laser gain medium 150 typically is a Nd:YVO₄ crystal although other laser crystals can also be used. When the laser power is below certain threshold, the SBR 160 absorbs the laser beam whereas above certain threshold, the absorption is saturated [e.g., U.S. Pat. No. 5,305,336]. The front surface of the SBR 160 is anti-reflective coated whereas the back surface of the SBR is highly reflective and acting as cavity end mirror at laser wavelength.

In FIG. 2, a prior art passively mode-locked laser is illustrated. The laser consists of a collimated pump source 210 with an optical pump beam 215, an output-deflecting pump coupler 220, a mode-matching lens 230, a highly reflective coating 240 serving as cavity end mirror and output coupler, a laser gain medium 250 with one flat end and a curved end, and a Saturable Bragg Reflector (SBR) 260. The pump source 210 typically is a semiconductor laser with an output wavelength centered about 808 nm. The output-deflecting pump coupler 220 transmits the pump beam at 808 nm while deflecting the laser output at 1064 nm. Normally, the surface of the output-deflecting pump coupler facing the pump source is coated with an anti-reflective coating whereas the surface facing the laser cavity is deposited with a dielectric coating which passes the pump beam at 808 nm while deflecting the laser output at 1064 nm. The function of the mode-matching lens 230 is to focus the collimated pump beam on the laser gain medium 250 to a size that best matches the laser cavity mode. The laser gain medium 250 normally is a Nd:YVO₄ crystal although other laser crystals can also be used. When the laser power is below certain threshold, the SBR 260 absorbs the laser beam whereas above certain threshold, the absorption is saturated. The front surface of the SBR 260 is anti-reflective coated whereas the back surface of the SBR is highly reflective and acting as cavity end mirror at laser wavelength.

There are several areas that can be improved on these prior art passively mode-locked lasers. For instance, once fabricated, these prior art lasers have fixed pulse repetition rates. For RF and microwave applications, however, one often requires tuning of the RF frequency. Therefore, an optical source with tunable pulse repetition rate is required for these RF and microwave applications. In addition, it is desirable to have optical to electrical conversion integrated with the optical RF sources. There is a need therefore to have improvements to these prior arts such that optical technology based RF sources can be made in a integrated device scheme and fabrication process.

### SUMMARY OF THE INVENTION

The present invention discloses an improved method and apparatus to obtain optical RF pulses utilizing a passively mode-locked, repetition rate tunable, solid-state laser technology. In accordance with one of the preferred embodiments, an optical RF source provides optical pulses with 1 to 200 GHz repetition rates. The disclosed optical RF source consists of a pump laser and mode matching optics, a pump beam coupler, a laser cavity end mirror, a laser gain medium, a Saturable Bragg Reflector, and a mechanism to adjust the effective optical path length of the cavity. By adjusting the effective optical path length of the laser resonator, the repetition rate of the output optical pulses is changed.

In another preferred embodiment, an optical RF source consists of a pump laser and mode matching optics, a Saturable Bragg Reflector which also serve as a pump coupler, a laser cavity end mirror, a laser gain medium, and a mechanism to adjust the effective optical path length of the cavity. By adjusting the effective optical path length of the laser resonator, the repetition rate of the output optical pulses is changed.

In an additional preferred embodiment, an optical RF source further includes an optical to electrical signal converter, and at least one of the following: an RF connector, a connecting waveguide, and a coaxial transmission cable with at least one terminating, impedance matching resistor.

In yet another preferred embodiment, an optical RF source consists of a pump laser and mode matching optics, a Saturable Bragg Reflector which also serve as a cavity end mirror, a laser cavity end mirror serving also as pump coupler, a laser gain medium, and a mechanism to adjust the effective optical path length of the cavity. By adjusting the effective optical path length of the laser resonator, the repetition rate of the output optical pulses is changed.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 illustrates the layout of a prior art passively mode-locked solid-state laser;

FIG. 2 shows the structure of a prior art high repetition rate passively mode-locked solid-state laser;

FIG. 3 displays an improved optical RF source with a tunable repetition rate;

FIG. 4 depicts another improved optical RF source with a tunable repetition rate;

FIG. 5 illustrates an improved RF source with a tunable repetition rate integrated with an optical to electrical pulse converter, an RF connector, or a connecting waveguide, or a coaxial cable and impedance matched terminal resistor;

FIG. 6 details yet another improved optical RF source with a tunable repetition rate.

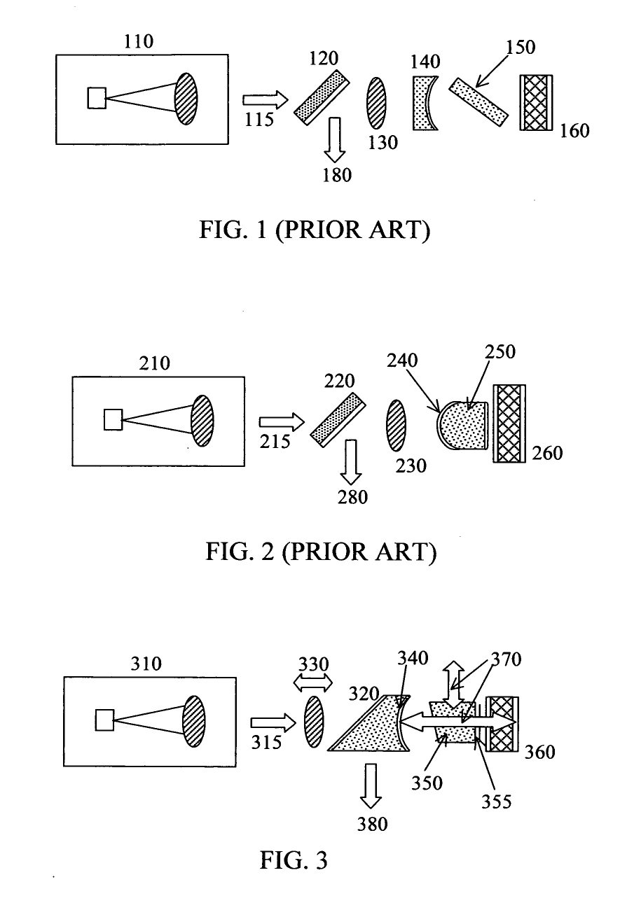

### DETAILED DESCRIPTION OF THE INVENTION

The present invention discloses a new method and apparatus to generate RF signals with a tunable pulse repetition rate. The improvements disclosed herein utilize a passively mode-locked solid-state laser in conjunction with a cavity tuning mechanism. The new method departs from both the prior art practices of electrically generated RF pulses, and conventional passively mode-locked lasers. The basic concept of the present invention is to generate an optical pulse train with a tunable repetition rate. The optical pulse train is then converted to a train of electrical RF pulses through an optical to electrical signal converter.

The first preferred embodiment of the present invention is illustrated in FIG. 3. A repetition rate tunable optical RF source consists of a collimated pump source 310 with an optical pump beam 315, a mode-matching lens 330, an output-deflecting pump coupler 320 combined with a cavity end mirror that also serves as laser output coupler 340, a laser gain medium 350, a Saturable Bragg Reflector (SBR) that also serves as the other end mirror of the cavity 360, and a tuning mechanism 370 to change the effective optical cavity length between the end mirrors 340 and 360. The pump source 310 typically is a semiconductor laser with an output wavelength centered about 808 nm or 880 nm for sufficient pump absorption by the laser gain medium. The output-deflecting pump coupler 320 has a dielectric coating that transmits the pump beam at 808 nm or 880 nm while deflecting the laser output at about 1064 nm, which is a typical laser wavelength for an Nd³⁺ doped laser gain medium. The function of the mode-matching lens 330 is to focus the collimated pump beam on the laser gain medium 350 to a size that best matches the specific cavity mode. The laser gain medium 350 normally is a Nd:YVO₄ crystal although other laser crystals such as Nd:Y_{1-X}Gd_{X}VO4 can also be used. Normally, the front surface of the laser gain medium has a dielectric coating that is anti-reflective for both the pump wavelength and the laser wavelength. The back surface of the laser gain medium (355) on the other hand, has a dielectric coating that is highly reflective for the pump wavelength and anti-reflective for the laser wavelength. When the laser power is below certain threshold, the SBR 360 absorbs the laser beam whereas above certain threshold, the absorption is saturated. The front surface of the SBR 360 is anti-reflective coated whereas the back surface of the SBR is highly reflective and acting as cavity end mirror at the laser wavelength. The tuning mechanism 370 consists of at least one position transducer attached to at least one of the following elements: the mode-matching lens 330, cavity end mirror 340, the laser gain medium 350, GF and the SBR 360. The position transducer converts an input signal to a physical distance and can be of mechanical, piezo-electric, electrical motor, thermal and other means. By adjusting the physical location of cavity elements 340, 350, and 360 individually or in combination, the effective optical path length of the cavity is tuned. The position of other optical elements (e.g., 330) may also need to be changed accordingly, to ensure best mode matching condition and/or system performance.

The repetition rate of the optical RF source depends sensitively on the optical length of the laser cavity. The optical length of the laser cavity is give by the relation L=L1+(n2−1)×L2+(n3−1)×L3, where L1 is the physical distance between the end mirror 340 and the high reflector side of the SBR 360, L2 and L3 are the physical thickness of the laser gain medium 350 and SBR, respectively, n2 and n3 are the refractive indices of the laser gain medium 350 and SBR 360, respectively, as illustrated in accordance with FIG. 3. The repetition rate of the optical RF source can be related to laser cavity optical length L in accordance with the following relation f=c/2L, where c is the speed of the light in vacuum.

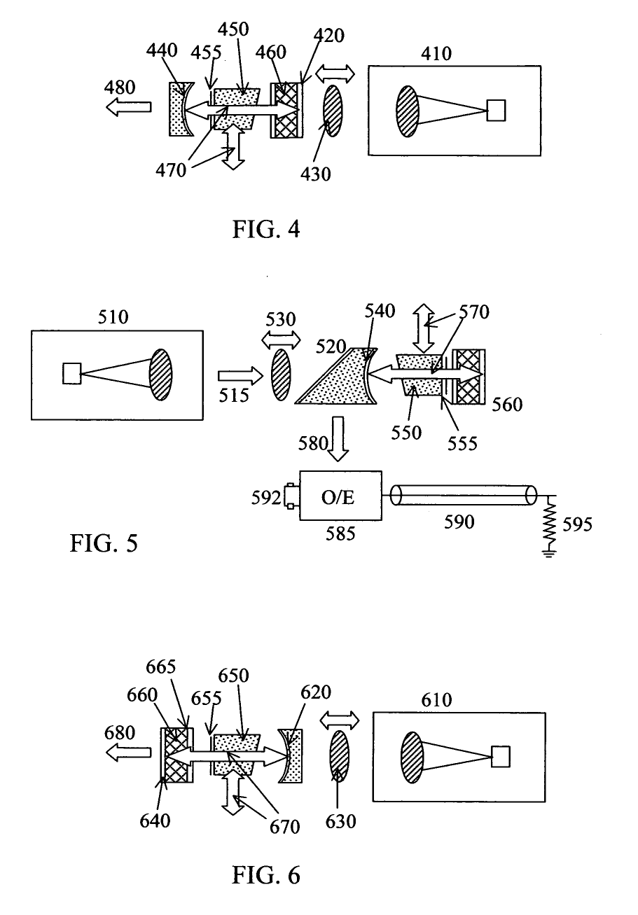

The second preferred embodiment of the present invention is illustrated in FIG. 4. A repetition rate tunable optical RF source consists of a collimated pump source 410 with an optical pump beam (not shown), a mode-matching lens 430, an output-reflecting pump coupler 420 combined with SBR 460, a laser gain medium 450, a cavity end mirror that also serves as laser output coupler 440, and a tuning mechanism 470 to change the effective optical cavity length between the end mirrors 440 and 420. The pump source 410 typically is a semiconductor laser with an output wavelength centered about 808 nm or 880 nm for sufficient pump absorption by the laser gain medium. The output-reflecting pump coupler 420 has a dielectric coating that transmits the pump beam at 808 nm or 880 nm while reflecting the laser output about 1064 nm, which is a typical laser wavelength for an Nd³⁺ doped laser gain medium. The function of the mode-matching lens 430 is to focus the collimated pump beam on the laser gain medium 450 to a size that best matches the specific laser cavity mode. The laser gain medium 450 normally is a Nd:YVO₄ crystal although other laser crystals such as Nd:Y_{1-X}Gd_{X}VO₄ can also be used. Normally, the back surface of the laser gain medium has a dielectric coating that is anti-reflective for both the pump wavelength and the laser wavelength. The front surface of the laser gain medium (455) on the other hand, has a dielectric coating that is highly reflective for the pump wavelength and anti-reflective for the laser wavelength. When the laser power is below certain threshold, the SBR 460 absorbs the laser beam whereas above certain threshold, the absorption is saturated. The front surface of the SBR 460 is anti-reflective coated whereas the back surface of the SBR is highly reflective and acting as cavity end mirror at the laser wavelength. The tuning mechanism 470 consists of at least one position transducer attached to at least one of the following elements: the mode-matching lens 430, the end mirror 440, the laser gain medium 450, or the SBR 460. The position transducer converts an input signal to a physical distance and can be of mechanical, piezoelectric, electrical motor, thermal and other means. By adjusting the physical location of cavity elements 440, 450, and 460 individually or in combination, the effective optical path length of the cavity is tuned. The position of other optical elements (e.g., 430) may also need to be changed accordingly, to ensure best mode matching condition and/or system performance.

The repetition rate of the optical RF source depends sensitively on the optical length of the laser cavity. The optical length of the laser cavity is give by the relation L=L1+(n2−1)×L2+(n3−1)×L3, where L1 is the physical distance between the end mirror 440 and the high reflector side of the SBR 460, L2 and L3 are the physical thickness of the laser gain medium 450 and SBR, respectively, n2 and n3 are the refractive indices of the laser gain medium 450 and SBR 460, respectively, as illustrated in accordance with FIG. 4. The repetition rate of the optical RF source can be related to laser cavity optical length L in accordance with the following relation f=c/2L, where c is the speed of the light in vacuum.

The third preferred embodiment of the present invention is illustrated in FIG. 5. A repetition rate tunable optical RF source consists of a collimated pump source 510 with an optical pump beam 515, a mode-matching lens 530, an output-deflecting pump coupler 520 combined with a cavity end mirror that also serves as laser output coupler 540, a laser gain medium 550, a Saturable Bragg Reflector (SBR) 560, and a tuning mechanism 570 to change the effective optical cavity length between the end mirrors 540 and 560. The optical RF source further comprises an optical to electrical signal converter 585; at least one of the following: a coaxial cable 590, an RF connector 592, a connecting waveguide (not shown), and at least one impedance matching, terminating resistor 595. The pump source 510 typically is a semiconductor laser with an output wavelength centered about 808 nm or 880 nm for sufficient pump absorption by the laser gain medium. The output-deflecting pump coupler 520 has a dielectric coating that transmits the pump beam at 808 nm or 880 nm while deflecting the laser output at about 1064 nm, which is a typical laser wavelength for an Nd³⁺ doped laser gain medium. The function of the mode-matching lens 530 is to focus the collimated pump beam on the laser gain medium 550 to a size that best matches the laser cavity mode. The laser gain medium 550 normally is a Nd:YVO₄ crystal although other laser crystals such as Nd:Y_{1-X}Gd_{X}VO₄ can also be used. Normally, the front surface of the laser gain medium has a dielectric coating that is anti-reflective for both the pump wavelength and the laser wavelength. The back surface of the laser gain medium (555) on the other hand, has a dielectric coating that is highly reflective for the pump wavelength and anti-reflective for the laser wavelength. When the laser power is below certain threshold, the SBR 560 absorbs the laser beam whereas above certain threshold, the absorption is saturated. The front surface of the SBR 560 is anti-reflective coated whereas the back surface of the SBR is highly reflective and acting as cavity end mirror at the laser wavelength. The tuning mechanism 570 consists of at least one position transducer attached to at least one of the following elements: the mode-matching lens 530, the end mirror 540, the laser gain medium 550, and the SBR 560. The position transducer converts an input signal to a physical distance and can be of mechanical, piezoelectric, electrical motor, thermal and other means. By adjusting the physical location of cavity elements 540, 550, and 560 individually or in combination, the effective optical path length of the cavity is tuned. The position of other optical elements (e.g., 530) may also need to be changed accordingly, to ensure best mode matching condition and/or system performance.

The optical to electrical signal converter 585 has a high signal bandwidth and fast response time that is suitable to convert the optical pulses with minimum signal distortion. The coaxial cable 590 can be high bandwidth cables such as RG 7/U, RG 9/U RG 87A/U, and RG 281/U. The RF connector 592 normally is designed for interconnect high bandwidth signals such as BNC, SMA, SMB and UHF connectors. The connecting high-speed waveguide are designed to minimize signal loss. The terminating resistor 595 serves to reduce the back reflection of the signal and have typical values of 50 ohms to 75 ohms, depending on the type of coaxial cable used.

The repetition rate of the optical RF source depends sensitively on the optical length of the laser cavity. The optical length of the laser cavity is give by the relation L=L1+(n2−1)×L2+(n3−1)×L3, where L1 is the physical distance between the end mirror 540 and the high reflector side of the SBR 560, L2 and L3 are the physical thickness of the laser gain medium 550 and SBR, respectively, n2 and n3 are the refractive indices of the laser gain medium 550 and SBR 560, respectively, as illustrated in accordance with FIG. 5. The repetition rate of the optical RF source can be related to laser cavity optical length L in accordance with the following relation f c/2L, where c is the speed of the light in vacuum.

The fourth preferred embodiment of the present invention is illustrated in FIG. 6. A repetition rate tunable optical RF source consists of a collimated pump source 610 with an optical pump beam (not shown), a mode-matching lens 630, a cavity end mirror and pump coupler 620, a laser gain medium 650, an SBR 660 combined with a cavity end mirror and output coupling coating 640, and a tuning mechanism 670 to change the effective optical cavity length between the end mirrors 640 and the 620. The pump source 610 typically is a semiconductor laser with an output wavelength centered about 808 nm or 880 nm for sufficient pump absorption by the laser gain medium. The curved cavity end mirror pump coupler 620 has a dielectric coating that transmits the pump beam at 808 nm or 880 nm while reflecting the laser output at about 1064 nm, which is a typical laser wavelength for an Nd³⁺ doped laser gain medium. The function of the mode-matching lens 630 is to focus the collimated pump beam on the laser gain medium 650 to a size that best matches the specific laser cavity mode. The laser gain medium 650 normally is a Nd:YVO₄ crystal although other laser crystals such as Nd:Y_{1-X}Gd_{X}VO₄ can also be used. Normally, the back surface of the laser gain medium has a dielectric coating that is anti-reflective for both the pump wavelength and the laser wavelength. The front surface of the laser gain medium (655) on the other hand, has a dielectric coating that is highly reflective for the pump wavelength and anti-reflective for the laser wavelength. When the laser power is below certain threshold, the SBR 660 absorbs the laser beam whereas above certain threshold, the absorption is saturated. The back surface of the SBR 665 is anti-reflective coated whereas the front surface of the SBR 640 is highly reflective and acting as cavity end mirror at the laser wavelength. The tuning mechanism 670 consists of at least one position transducer attached to at least one of the following elements: the mode-matching lens 630, the cavity end mirror 640, the laser gain medium 650, and the curved end mirror 620. The position transducer converts an input signal to a physical distance and can be of mechanical, piezoelectric, electrical motor, thermal and other means. By adjusting the physical location of cavity elements 640, 650, and 620 individually or in combination, the effective optical path length of the cavity is tuned. The position of other optical elements (e.g., 630) may also need to be changed accordingly, to ensure best mode matching condition and/or system performance.

The repetition rate of the optical RF source depends sensitively on the optical length of the laser cavity. The optical length of the laser cavity is give by the relation L=L1+(n2−1)×L2+(n3−1)×L3, where L1 is the physical distance between the end mirror 640 and the curved end mirror coating 620, L2 and L3 are the physical thickness of the laser gain medium 650 and SBR 660, respectively, n2 and n3 are the refractive indices of the laser gain medium 650 and SBR, respectively, as illustrated in accordance with FIG. 6. The repetition rate of the optical RF source can be related to laser cavity optical length L in accordance with the following relation f=c/2L, where c is the speed of the light in vacuum.

It will be apparent to those with ordinary skill of the art that many variations and modifications can be made to the method and apparatus of optical RF source disclosed herein without departing from the spirit and scope of the present invention. It is therefore intended that the present invention cover the modifications and variations of this invention provided that they come within the scope of the appended claims and their equivalents, we claim:

1. An optical RF source for providing pulse repetition rate tunable optical output comprising:
at least one optical gain element having the function of optical amplification;
a cavity having at least two light reflectors placed at a distance apart and enclosing the said optical gain element;
at least one optical absorption element having a limited absorption capability;
at least one optical pump source having a continuous wave pump light output;
at least one beam shaping lens to collimate and focus the said pump light output;
at least one position transducer attaching to at least one of the said reflectors, optical gain element(s), pump source(s), and lens(s);
at least one pump beam coupler to couple the said pump light output to the said laser cavity.

2. The optical RF source recited in claim 1 wherein the said optical gain element being a solid containing Neodymium cations.

3. The optical RF source recited in claim 1 wherein the said optical gain element being a solid containing Lanthanides or Actinides cations.

4. The optical RF source recited in claim 1 wherein the said reflectors having reflectivity in the range of 0.1 to 1.0.

5. The optical RF source recited in claim 1 wherein the said reflectors having a physical separation of 0.1 to 100 mm.

6. The optical RF source recited in claim 1 wherein at least one of the reflectors has a substantial curvature.

7. The optical RF source recited in claim 1 wherein the said cavity further containing an intra-cavity lens.

8. The optical RF source recited in claim 1 wherein the said position transducer containing a fine thread based mechanical arrangement.

9. The optical RF source recited in claim 1 wherein the said position transducer containing an electrical motor.

10. The optical RF source recited in claim 1 wherein the said position transducer containing a piezoelectric crystal.

11. The optical RF source recited in claim 1 wherein the said position transducer changes position by 0.1 to 100 mm.

12. The optical RF source recited in claim 1 wherein the said beam shaping lens having focal length of 0.1 mm to 500 mm.

13. An optical RF source for providing pulse repetition rate tunable optical output comprising:
at least one optical gain element having the function of optical amplification;
a cavity having two reflectors placed at a distance apart and enclosing the said optical gain element;
at least one optical absorption element having a limited absorption capability;
at least one position transducer attaching to at least one of the said reflectors and the optical gain element(s).

14. The optical RF source recited in claim 13 wherein the said optical gain element being a solid containing Neodymium cations.

15. The optical RF source recited in claim 13 wherein the said optical gain element being a solid containing Lanthanides or Actinides cations.

16. The optical RF source recited in claim 13 wherein the said reflectors having reflectivity in the range of 0.1 to 1.0.

17. The optical RF source recited in claim 13 wherein the said reflectors having a physical separation of 0.1 to 100 mm.

18. The optical RF source recited in claim 13 wherein at least one of the reflectors has a substantial curvature.

19. The optical RF source recited in claim 13 wherein additional position transducers attaching to additional components being included.

20. The optical RF source recited in claim 13 wherein the said position transducer containing a fine thread based mechanical arrangement.

21. The optical RF source recited in claim 13 wherein the said position transducer containing an electrical motor.

22. The optical RF source recited in claim 13 wherein the said position transducer containing a piezoelectric crystal.

23. A method for generating repetition rate tunable RF pulses comprising the following steps:
optically pumping a mode-locked laser;
generating light pulses having a predetermined repetition rate;
converting the light pulses into electrical pulses;
transmitting the electrical pulses through an RF connector, or a waveguide, or a coaxial cable.

24. The method recited in claim 23 wherein the said mode-locked laser comprising a gain element, two reflectors and a saturable absorption element.

25. The method recited in claim 23 wherein the said repetition rate being from 1 to 200 GHz.

26. The method recited in claim 23 wherein the said mode-locked laser comprising, an optical pump source, a gain element, two reflectors and a saturable absorption element.
